(19) United States
(12) Patent Application Publication
(10) Pub. No.: US 2025/0209053 A1
(43) Pub. Date: Jun. 26, 2025

(54) COLLABORATIVE GENERATIVE ARTIFICIAL INTELLIGENCE CONTENT IDENTIFICATION AND VERIFICATION

(71) Applicant: QOMPLX LLC, Reston, VA (US)

(72) Inventors: Jason Crabtree, Vienna, VA (US); Richard Kelley, Woodbridge, VA (US); Jason Hopper, Halifax (CA); David Park, Fairfax, VA (US)

(21) Appl. No.: 18/395,482

(22) Filed: Dec. 23, 2023

(51) Int. Cl. G06F 16/22

(52) U.S. Cl. CPC G06F 16/2255

(57) ABSTRACT

The Generative AI Content Verification Exchange systematically registers and stores content generated by AI-enabled or enhanced services. Upon submission, the system categorizes content into distinct groups, then deconstructs it into multiple segments using various methods. Each segment is assigned a unique hash value, termed a “part identifier,” ensuring individualized identification. This registration process, combining grouping, segmentation, and hashing, enhances content traceability and retrieval. The resulting database not only organizes generated content by groups but also allows for efficient and secure referencing of specific content segments. The systematic registration and storage framework enable streamlined management of diverse generative AI-generated content for various applications, such as registration, analysis, search, and verification by diverse counterparties.

### CROSS-REFERENCE TO RELATED APPLICATIONS

Priority is claimed in the application data sheet to the following patents or patent applications, each of which is expressly incorporated herein by reference in its entirety:
None

### BACKGROUND OF THE INVENTION

### Field of the Art

The present invention is in the field of content identification, and more particularly to identification and verification of human-generated versus artificial intelligence-generated or derived content.

### Discussion of the State of the Art

With the rise of Generative Artificial Intelligence (GenAI) there has been an explosion in generated digital content that is often nearly impossible to distinguish from human generated content. This is especially problematic when the volume of generated images and text that is flooding the internet is considered. So-called “deep fakes”, where people in an existing image or video are replaced with someone else's likeness using artificial neural networks have raised concerns across industry and governments. Newer techniques can even support generation of images, video, or sound where no initial likeness is replaced. Generated text has proliferated on the Internet at record speed where bots are creating realistic sounding journal and news articles, students are generating research papers, and lawyers are using GenAI to automatically generate important legal documents, albeit with mixed results.

Public calls to regulate GenAI have reached the White House, prompting an executive order from the current administration that “establishes new standards for AI safety and security, protects Americans' privacy, advances equity and civil rights, stands up for consumers and workers, promotes innovation and competition, advances American leadership around the world, and more.” Among the requirements is to: protect Americans from AI-enabled fraud and deception and the development of guidance for content authentication and watermarking to clearly label AI-generated content.

It is important to note that the mandates face several critical challenges; two of the most pressing relate to the verification of any proposed watermark or similar type of labeling and the separate challenge of addressing generative content where illicit actors (who are not likely to behave in accordance with government mandates) are the content generator or distributor. While watermarking goes a long way to help identify GenAI content, if the content is duly marked by a creating process or service, there is still a matter of how one verifies a watermark or otherwise prove to some degree of certainty that content is indeed output from GenAI.

What is needed is a generative AI content verification exchange capability that enables diverse counterparties to engage in the “clearing” of content.

### SUMMARY OF THE INVENTION

Accordingly, the inventor has conceived and reduced to practice, a system and method for providing Generative AI Content Verification Exchange which systematically registers and stores content generated by AI. Upon submission, the system categorizes content into distinct groups, then deconstructs it into multiple segments using various methods. Each segment is assigned a unique hash value, termed a “part identifier,” ensuring individualized identification. This registration process, combining grouping, segmentation, and hashing, enhances content traceability and retrieval. The resulting database not only organizes generated content by groups but also allows for efficient and secure referencing of specific content segments. The systematic registration and storage framework enable streamlined management of diverse generative AI-generated content for various applications, such as analysis, search, and verification.

According to a preferred embodiment, a system for collaborative generative artificial intelligence (GenAI) content identification and verification is disclosed, comprising: a plurality of computing devices each comprising at least a processor, a memory, and a network interface; wherein a plurality of programming instructions stored in one or more of the memories and operating on one or more of the processors of the plurality of computing devices causes the plurality of computing devices to: receive generated content from a generating service; assign a service identifier to the generated content, wherein the service identifier is associated with the generating service; deconstruct the generated content into a plurality of data segments; for each data segment: use a hashing algorithm to assign a segment identifier; link the segment identifier with the service identifier; add the segment identifier to a content group; store the content group in a database.

According to another preferred embodiment, a method for collaborative generative artificial intelligence (GenAI) content identification and verification is disclosed, comprising: receiving generated content from a generating service; assigning a service identifier to the generated content, wherein the service identifier is associated with the generating service; deconstructing the generated content into a plurality of data segments; for each data segment: using a hashing algorithm to assign a segment identifier; linking the segment identifier with the service identifier; adding the segment identifier to a content group; storing the content group in a database.

According to an aspect of an embodiment, the generating service uses a generative artificial intelligence system to create the generated content.

According to an aspect of an embodiment, the generated content is multimedia content.

According to an aspect of an embodiment, the hashing algorithm is a perceptual hashing algorithm.

According to an aspect of an embodiment, the plurality of data segments is not uniform.

According to an aspect of an embodiment, the generated content is human created content.

### BRIEF DESCRIPTION OF THE DRAWING FIGURES

FIG. 1 is a block diagram illustrating an exemplary system architecture for collaborative generative artificial intelligence content identification and verification, according to an embodiment.

FIG. 2 is a block diagram illustrating an exemplary embodiment of a generative artificial intelligence content verification exchange.

FIG. 3 is a block diagram illustrating an exemplary system architecture for providing public content registration to a global utility service using a generative artificial intelligence content verification exchange, according to an embodiment.

FIG. 4 is a block diagram illustrating an exemplary system architecture for collaborative generative artificial intelligence (AI) content identification and verification with private networks, according to an embodiment.

FIG. 5 is a block diagram illustrating an exemplary system architecture for collaborative generative artificial intelligence (AI) content identification and verification using a federated architecture.

FIG. 6 is a diagram illustrating an exemplary content registration library, according to an embodiment.

FIG. 7 is a block diagram illustrating an exemplary method for registering received content using a GenAI CVX, according to an embodiment.

FIG. 8 is a method diagram illustrating an exemplary method for assigning a part identifier using a perceptual hashing function, according to an embodiment.

FIG. 9 illustrates an exemplary computing environment on which an embodiment described herein may be implemented.

### DETAILED DESCRIPTION OF THE INVENTION

The inventor has conceived, and reduced to practice, a system a and method for Generative AI Content Verification Exchange systematically registers and stores content generated by AI-enabled or enhanced services. Upon submission, the system categorizes content into distinct groups, then deconstructs it into multiple segments using various methods. Each segment is assigned a unique hash value, termed a “part identifier,” ensuring individualized identification. This registration process, combining grouping, segmentation, and hashing, enhances content traceability and retrieval. The resulting database not only organizes generated content by groups but also allows for efficient and secure referencing of specific content segments. The systematic registration and storage framework enable streamlined management of diverse generative AI-generated content for various applications, such as registration, analysis, search, and verification by diverse counterparties.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Conceptual Architecture

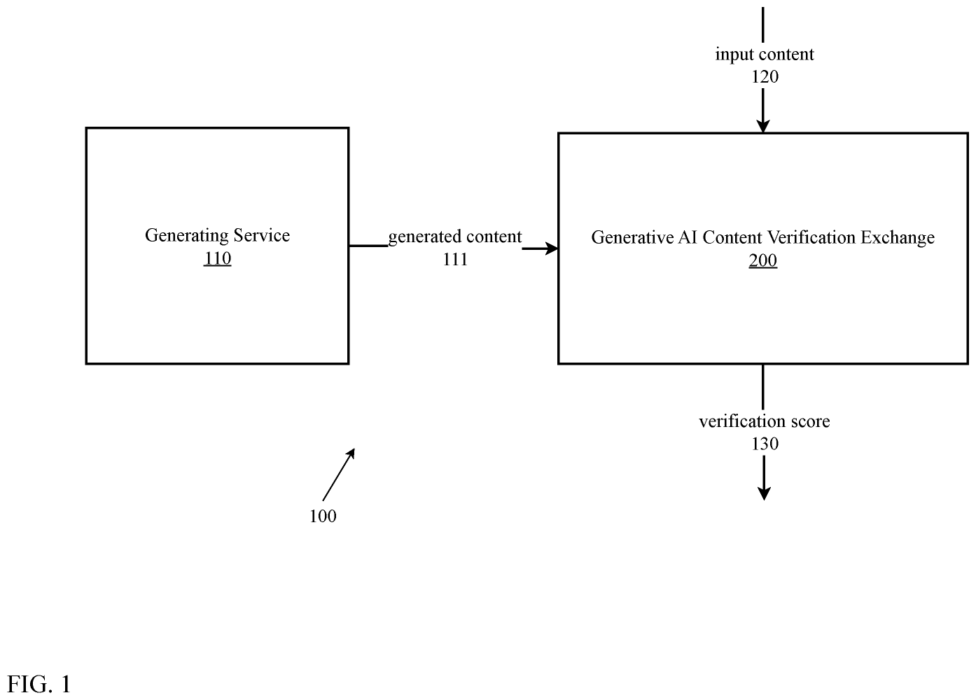

FIG. 1 is a block diagram illustrating an exemplary system architecture 100 for collaborative generative artificial intelligence (AI) content identification and verification, according to an embodiment. According to the embodiment, the system comprises one or more generating services 110 which can employ various generative artificial intelligence systems and/or models to generate a plurality of content including, but not limited to, images, illustration, photo, multimedia, podcast, music, endorsement, artwork, video, audio, text, and computer programming instructions (i.e., software code). A generating service 110 may receive a prompt to generate content from a user and present the generated content 111 to the user or to a downstream application or process. Examples of generation services which may be integrated with the generative AI content verification exchange 200 include OpenAI's GPT, Midjourney, BERT, StyleGAN, DALL-E, WaveGAN, Deepfake, and/or the like.

Each generating service 110 is configured to send generated content 111 to a generative AI content verification exchange (GenAI CVX). GenAI CVX 200 may create a collection of hashes to represent the generated content. In an embodiment, the collection of hashes may additionally represent select metadata associated with the generated content. For example, metadata can include device identifiers, IP address, MAC address, IEINs, and/or the like. In a basic, simple example, a single generated content may have a corresponding single hash value which represents the single generated content. Generally, a generated content will have multiple hash values (e.g., a set or collection of hash values) which collectively represent the single generated content. For example, if the generated content was a generated image, then the image may be divided into multiple parts and each part assigned a hash, thereby the generated image is represented by the set of hashes defined to each part of the generated image. If, for example, the generated content is generated text, then the text can be divided into chunks for phrases contained in the content, and then each chunk can be assigned a hash value.

A collection of hash values which represent a generated content 111 from a generation service 110 may be referred to as a “content group.” When a generating service 110 generates new content 111, GenAI CVX 200 simultaneously creates content group hash data associated with the received generated content. Each submission to GenAI CVX 200 can be stored as a related content group and each hash may be independently searchable at a global datastore level. GenAI CVX 200 may utilize one or more databases for storing the plurality content groups associated with the received content from various generating services 110. In an embodiment, the hashes may be derived from some sort of known metric such as Levenshtein distance and image similarity scoring methods. In an embodiment, perceptual hashing (phash) is implemented. In an embodiment, locally sensitive hashing (LSH) is implemented. There are several variants of phash and LSH that may be implemented according to various aspects, but the idea is that small changes in the input will have a small change on the output. For example, if there was an image of a child riding a blue bike and another image of that is identical but with a red bike, a phash or LSH would yield two outputs that are very close by edit difference (e.g., ABCDE and ABCDD). With a low edit distance (1 in the previous example) the two inputs would be considered “similar”.

The exchange may be centrally located with a third party (public or private) or provided by the generating service directly. This can allow for the verification of whole pieces of content that have not been modified. In some implementations, GenAI CVX can verify content embedded in other content or otherwise modified (additive or subtractive to some extent). Using a combination of random sampling and part identifiers, GenAI CVX can perform granular content verification to identify embedded content. For example, a specific melody of an input music sample may be identified and isolated from the other melodies and encompassing song altogether, wherein the specific melody may be a registered content.

GenAI CVX 200 can provide content verification. When an external party wants to check if content is possibly generated by AI, they can submit the content 120 to GenAI CVX 200 for verification. According to an embodiment, during verification GenAI CVX 200 may break up the input content 120 (e.g., image or text) into random parts (e.g., sub-images and phrases respectively), call candidate groups and compare hashes across the known corpus of submitted content at the global datastore level. If there is a match for any of the hashes, then the entire collection of submitted hashed would then be compared against the content group submitted by the generating service 110. This allows GenAI CVX 200 to produce a match or similarity/verification score 130 based on the hashed data across the group. A higher score across the group would indicate a higher likelihood that the input content 120 was generated as part of the original submission.

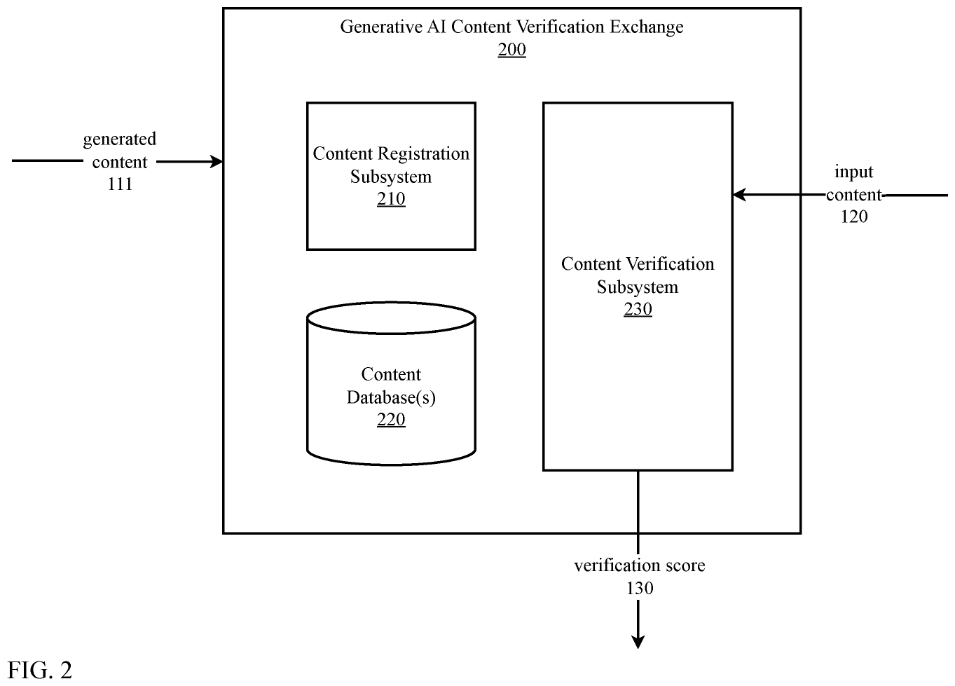

FIG. 2 is a block diagram illustrating an exemplary embodiment of a generative artificial intelligence content verification exchange 200. According to the embodiment, GenAI CVX 200 may receive generated content 111 which was generated by a generation service 110 or, in some implementations, generated content may comprise content created by a human, wither with or without, the assistance of a AI system. The received generated content 111 may be processed by a content registration subsystem 210 configured to prepare the received content for storage in content database(s) 220. An image may be used in FIG. 2 as an exemplary generated content 111 received by GenAI CVX 200. Content registration subsystem 210 may be configured to create content group hash data associated with submitted content 111. The content group hash data may comprise a plurality of hash values which represent content generated by generation service 110.

Content registration subsystem 210 may assign a unique content group identifier (ID) to the received image. In some implementations, the group identifier may be referred to as a service identifier. Content registration subsystem 210 may then break the image into a plurality of parts (e.g., “data chunks” or “chunks”) Pᵢ. The function/process that breaks the image into parts may vary and it may not necessarily yield uniform parts. As a simple example, an image may be broken down into four parts which represent four different quadrants of the image. In some implementations, the content may be divided into smaller parts randomly. In some implementations, image content may be processed via image segmentation techniques such as, for example, grid-based segmentation, quadtree decomposition, k-means clustering, edge based segmentations, region growing, superpixel segmentation, and/or the like. In some implementations, machine learning may be employed to determine how to break the content into smaller parts. For example, a machine learning model may be trained to break the generated content into a plurality of parts based on various features such as the type of generated content received (e.g., video, photo, illustration, music, artwork, text, speech, endorsement, etc.), the generating service which generated the content, the prompt associated with the generated content, metadata associated with the generated content, historical data chunking information,

Content registration subsystem 210 can transform each of the plurality of smaller parts Pᵢ into a part identifier Pᵢ′ with a one-way function such that:

T(Pᵢ)=Pᵢ′

where function T is some method for assigning an identifier (e.g., a hashing algorithm). Content registration subsystem 210 may then store the content group/service ID and part identifiers in content database(s) 220. The data stored in content database(s) 220 may be used by content verification subsystem 230 to facilitate AI content verification of input content.

GenAI CVX 200 can verify if input content 120 is content which was created by a generative AI service. Continuing with an image as the content to be verified, content verification subsystem 230 can receive input content 120 which is to be compared with stored hash values to determine if the input content was generated by an AI generation service. The input content 120 may be received by content verification subsystem 230 and broken into random parts Pᵢ. Each Pᵢ is transformed into a part identifier Pᵢ′. Next, the content database(s) 220 is checked for part identifier Pᵢ′. If Pᵢ′ is found in content database(s) 220, then content verification subsystem 230 can compute a match score for that content group. For example, the match score could be a simple percentage or other more complex scoring method. The process may iterate through each Pᵢ′ in content database(s) until all matched part identifiers have been exhausted. This system has both affirmative value when input content 120 does appear in content database(s) 220 and must simultaneously contend with the issue of when content does not appear in the content database(s) 220. In these cases, referred to as non-registered content, there is no original “claimed” content submission. Thus, a comparative request or verification request adds the input content to the broader database.

The larger the hash group originally submitted by the generating service 210, the more accurate the verification could be since there would be a larger pool of hashes to compare against for any given content group. Since sampling can occur within different “scopes” associated with work, the random selection of candidates can help to reduce gaming the system by modifying small parts of the content such as trimming the edges of an image or changing small portions of text (e.g., changing happy to glad or one note in a melody). Multiple measures of distance across the associated hypercube can be generated. Distance between vectorized representations of different measures associated with various content pieces can be compared. Optional visualizations of the multiple dimensions in two-dimensional space can be produced to aid users in understanding similarity on demand such as, t-distributed stochastic neighbor embedding, Chinese restaurant process, or various clustering algorithms (e.g., variant based on k-means).

According to the embodiment, content database(s) 220 may employ one or more data storage devices and/or systems. In an embodiment, relational databases like MySQL, PostgreSQL, or NoSQL databases like MongoDB may be implemented for efficient storage and retrieval.

With respect to breaking the content into smaller chunks of bits and then fingerprinting (e.g., assigning part identifiers) them individually, sampling approaches can be used individually or collectively to reduce the likelihood of false negatives or false positives. In an embodiment, this may be varied as a function of the content's value against an objective function (e.g., monetary value of a key work-like the Mona Lisa or a critical bit of content such as a State of the Union Address). For images or audio in particular this kind of approach can be more robust when considering basic transformations (e.g., resizing, cropping, noise reduction, etc.).

In an implementation, content registration subsystem 210 may be further configured to perform optional categorization of various “categories” of content. For example, foreign policy related statements (e.g., trade, war, etc.) might be category one and require several different measures to establish veracity in order to be reported on by responsible news agencies, whereas a social media post about the comings and goings of an average citizen could be a category 10 and require little, if any analysis.

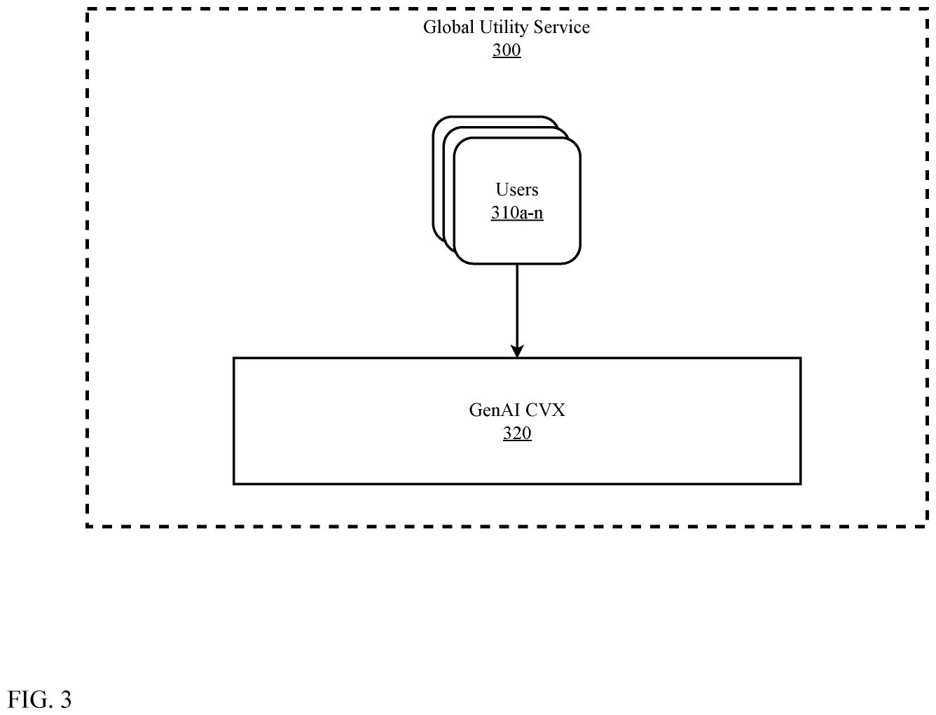

FIG. 3 is a block diagram illustrating an exemplary system architecture for providing public content registration to a global utility service using a generative artificial intelligence content verification exchange, according to an embodiment. A single global utility service 300 with public content registration refers to an online platform or service that serves as a universal utility for users worldwide. This service allows users 310a-n to register and share content, and the shared content is publicly available for others to view. Examples of platforms that provide global utility services include Facebook and Twitter, where users from around the world can share various types of content and engage with the public or a specific audience.

According to the embodiment, a global utility service 300 with a plurality of users 310a-n is present and comprises a GenAI CVX 320 configured to receive content created by the plurality of users 310a-n and register the content according to various methods described herein.

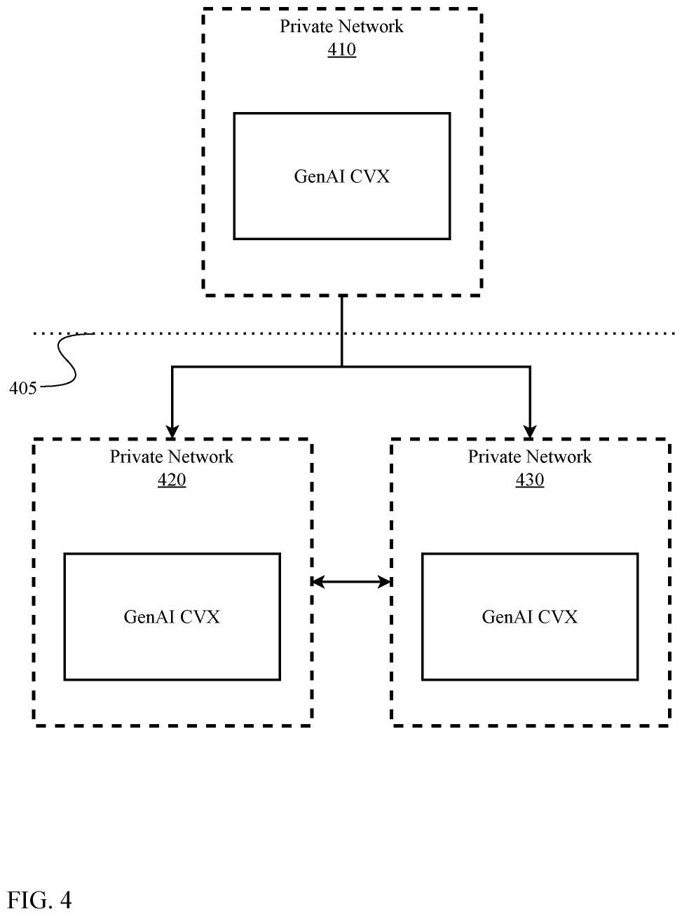

FIG. 4 is a block diagram illustrating an exemplary system architecture for collaborative generative artificial intelligence (AI) content identification and verification with private networks, according to an embodiment. According to the embodiment, the system may comprise two or more private networks 410, 420, 430 which may also be referred to herein as “private enclaves”. Private enclaves refer to isolated and restricted spaces or networks that are separate from the public or general-purpose networks. These enclaves are designed to provide a higher level of security and control over the information within them. This embodiment is composed of multiple interconnected but independent entities or networks. These entities may cooperate and share information while maintaining a degree of autonomy. According to the embodiment, the private networks may comprise a hierarchy or otherwise be arranged such that each private network does not necessarily have access to information stored in a different private network. For example, consider that each private network has its own clearance level, wherein private network 410 possesses top level clearance and may access all information stored in lower clearance level private networks. A line 405 delineates the varying levels of access which may be present in an arrangement of private networks. Continuing the example, private networks 420, 430 may belong in a lower clearance level and may only have access to each other and any other private networks with the same level of clearance.

According to the embodiment, each of the private networks 410, 420, 430, may comprise a GenAI CVX configured to register and store content associated with its respective private network. Only private networks with the proper clearance/access level would be able to search, match, and/or verify the stored, registered content contained within other private networks. In such embodiments, during content lookup, the GenAI CVX will first do a local search of the content database(s) located within that instance within the private network, and then move on to other linked private networks and search against their content databases. For example, private network 410 may first compare input content against registered content within its own database and then move down to subordinate private networks 420 and 430 to search against their content databases.

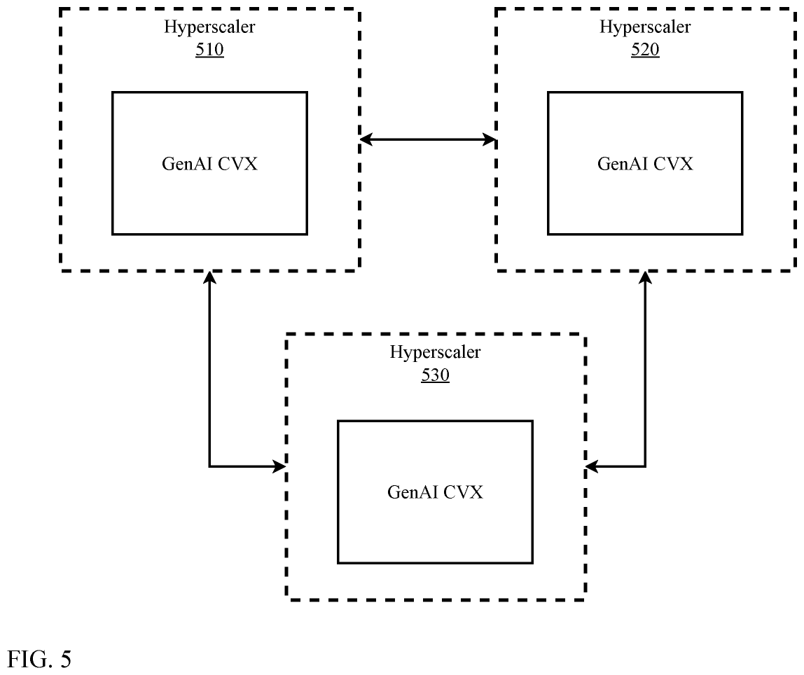

FIG. 5 is a block diagram illustrating an exemplary system architecture for collaborative generative artificial intelligence (AI) content identification and verification using a federated architecture. According to the embodiment, the system may comprise a plurality of entities arranged in a federated architecture wherein each of the entities may maintain autonomy but allows these different isolated environments to collaborate with limited information exchange. As illustrated exemplary entities are represented as three separate hyperscalers 510, 520, and 530. Hyperscalers are large cloud service providers, which can provide services such as computing and storage at enterprise scale and may comprise a large network of data centers. Exemplary hyperscalers can include Microsoft Azure, Amazon Web Services, and Google Cloud Platform.

According to the embodiment, each hyperscaler may employ a GenAI CVX configured to compile and maintain a registry of content associated with that particular hyperscaler. For example, a generation service 110 that utilize a hyperscaler's services, such as computing resources for generative AI processing, can have its content registered with the GenAI CVX associated with that hyperscaler. Due to the federated nature of these entities, there is limited information exchange between and among entities. However, limited information may be exchanged to support mutual verification. For example, a hyperscaler may implement private keys to facilitate information exchange.

### Detailed Description of Exemplary Aspects

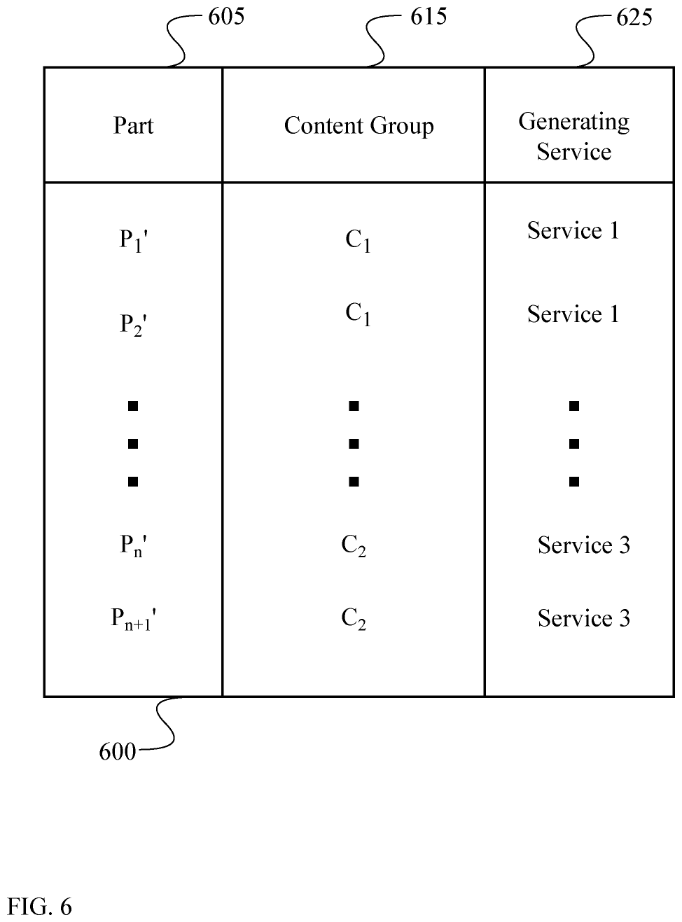

FIG. 6 is a diagram illustrating an exemplary content registration library 600, according to an embodiment. According to the embodiment, the content registration library 600 may be configured to store information associated with registered content. In some implementations, content registration library 600 may be stored in content database 220. In an embodiment, the registered content corresponds to content generated by one or more generating services which employ generative AI systems/models to produce content. The content produced by the one or more generating services may be sent to a GenAI CVX which can register the received content by assigning a content group to a received content, dividing the received content into a plurality of parts, assigning a hash value to each part, and storing the content group, the hash values, and the generating service in a content registration library 600.

As shown, content registration library 600 may act as a corpus of generated content associated with a plurality of generating services. In an embodiment, the library may store information associated with each part 605 of a received generated content. Each part may be assigned an identifier such as a hash value, and this part identifier may be stored in the library. Each part is linked to a content group 615, and a single content group may comprise a collection of hash values (i.e., part identifiers). Additionally, each registered part is linked to the generating service 625 which generated the original content submitted to GenAI CVX. In this way, each part may be individually searched, a content group may be searched, and a generating service may be searched at varying levels of granularity. In some embodiments, additional information such as metadata, or information related to the prompt associated with the submitted, generated content may be stored in library 600.

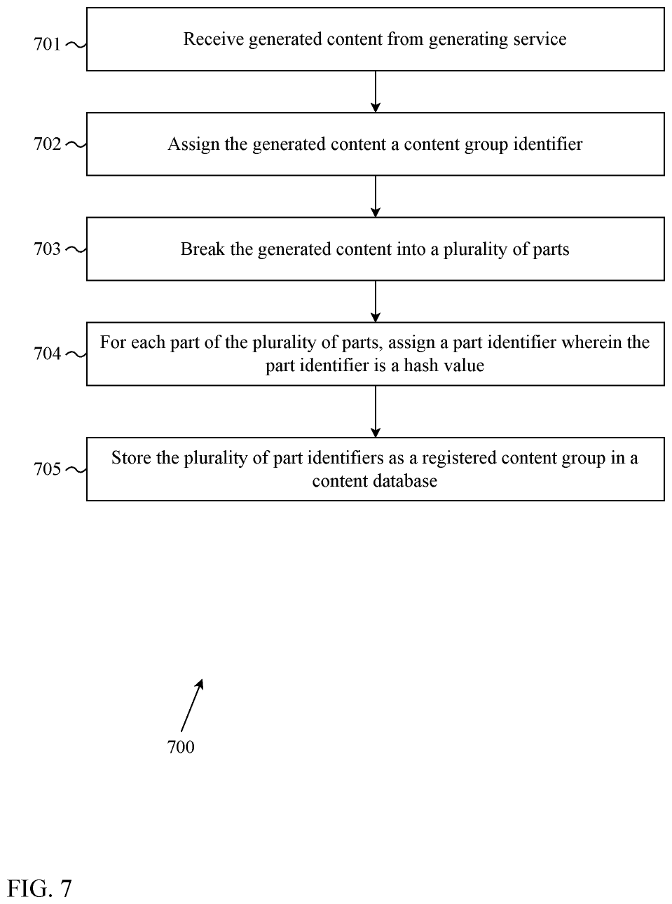

FIG. 7 is a block diagram illustrating an exemplary method 700 for registering received content using a GenAI CVX, according to an embodiment. According to the embodiment, the process begins at step 701 when GenAI CVX 200 receives generated content from a generating service 110. In an embodiment, the received content is multimedia content, wherein the multimedia content may be generated by a generating service. At step 702, the submitted content is assigned a content group. This content group may be denoted by an unique identifier. The content group may act as a global identifier for any constituent parts or derivative content derived from the submitted content. As a next step 703, GenAI CVX can break the generated content into a plurality of parts. This may be achieved using various methods that may be dependent upon several factors including, but not limited to, the type of content being processed, the computing resources available, business rules or logic or some other constraints, and/or the like. An input image may be divided into smaller sub-images. An input text may be divided into smaller phrases. The content may be segmented into a plurality of data chunks. The data chunks need not be uniform in size or dimension.

As a next step 704, each part of the plurality of parts is assigned a part identifier. In an embodiment, the part identifier is a hash value determined by a hashing algorithm. In an embodiment, perceptual hashing may be implemented to assign part identifiers to each of the plurality of segmented parts. In an embodiment, locally sensitive hashing is implemented to assign part identifiers to each of the plurality of segmented parts. As a last step 705, GenAI CVX 200 can store the plurality of part identifiers as a registered content group in a content database. The content database may also be referred to as a registered content library 600. The registered content group may comprise a collection of hash values (i.e., part identifiers), a group/service identifier, and the generating service which produced the generated content.

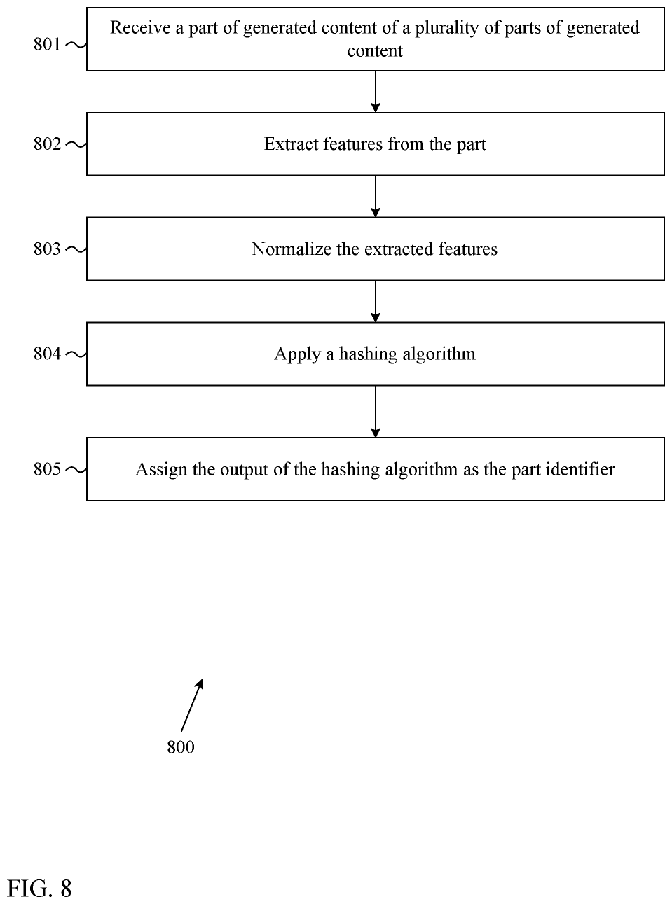

FIG. 8 is a method diagram illustrating an exemplary method 800 for assigning a part identifier using a perceptual hashing function, according to an embodiment. According to the embodiment, the process begins at step 801 when a GenAI CVX has broken submitted content into a plurality of parts and a first part is to be processed. At step 802 content registration subsystem 210 may extract key features from the part. In the use case of images, these features could include color distribution, texture, and other visual characteristics. At step 803 the extracted features are normalized to reduce sensitivity to variations such as lighting conditions, orientation, or scaling. This step aims to make the hash more robust against minor changes that do not significantly affect perceptual similarity. At step 804 a hashing algorithm is applied to the normalized features to generate a hash value. For example, perceptual hashing algorithms that may be used for image processing include pHash, dHash, and aHash. The hashing algorithm should produce a fixed-size hash that represents the unique characteristics of the content. The key aspect of perceptual hashing is that similar content should produce similar hash values. This means that even if the content has undergone minor alterations or transformations (e.g., resizing, compression, slight color changes), the hash values should remain close. The hash value may be assigned to the part as a part identifier at step 805. The part identifier may be associated with a content group and stored in database 220.

### Exemplary Computing Environment

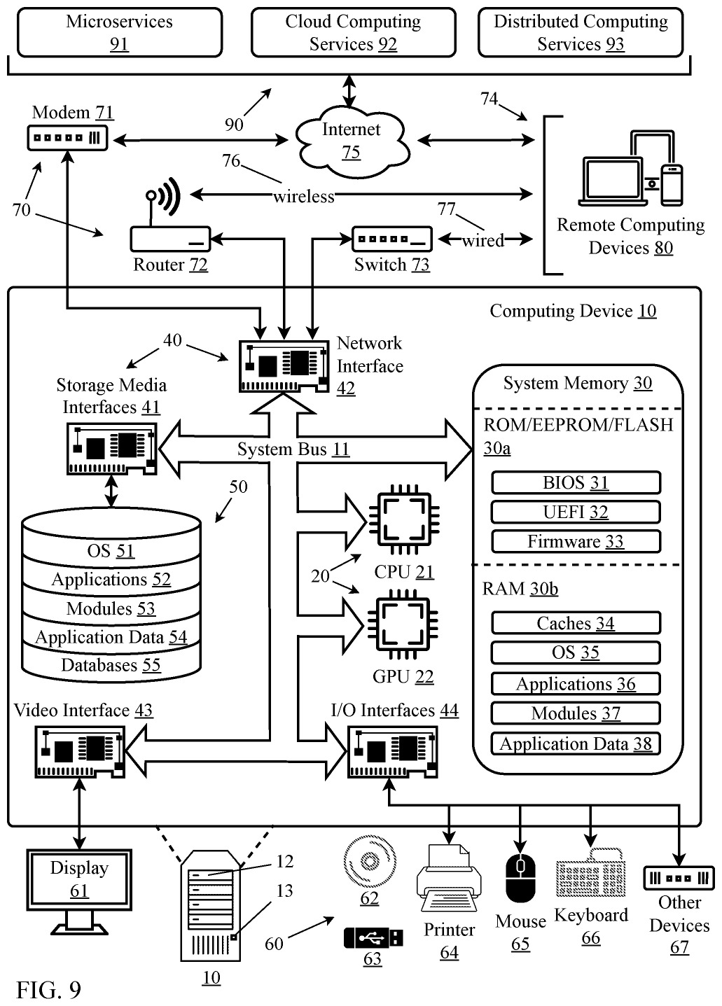

FIG. 9 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between, those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions. Further, computing device 10 may comprise one or more specialized processors such as a graphics processing unit (GPU) 22 configured to accelerate processing of computer graphics and images via a large array of specialized processing cores arranged in parallel. System memory 30 is processor-accessible data storage in the form of volatile and/or

nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, and graph databases. In some implementations, data storage devices may be volatile, non-volatile, or semi-volatile, or some combination thereof.

Applications (also known as computer software or software applications) are sets of programming instructions designed to perform specific tasks or provide specific functionality on a computer or other computing devices. Applications are typically written in high-level programming languages such as C++, Java, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network. Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices.

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. In an embodiment, computing device 10 may be implemented as a virtualized computing device.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is Docker, which is widely used in software development and deployment. Containerization, particularly with open source technologies like Docker and container orchestration systems like Kubernetes, is a common approach for deploying and managing applications. Containers are created from images, which are lightweight, standalone, and executable packages that include application code, libraries, dependencies, and runtime. Images are often built from a Dockerfile, which contains instructions for assembling the image. Dockerfiles are configuration files that specify how to build a Docker image. They include commands for installing dependencies, copying files, setting environment variables, and defining runtime configurations. Docker images are stored in repositories, which can be public or private. Docker Hub is a public registry, and organizations often set up private registries for security and version control. Containers can communicate with each other and the external world through networking. Docker provides a bridge network by default, but can be used with custom networks. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, main frame computers, network nodes, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP or message queues. Microservices 91 can be combined to perform more complex processing tasks.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over the Internet on a subscription basis.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

1. A system for collaborative generative artificial intelligence content identification and verification, comprising:
a plurality of computing devices each comprising at least a processor, a memory, and a network interface;
wherein a plurality of programming instructions stored in one or more of the memories and operating on one or more of the processors of the plurality of computing devices causes the plurality of computing devices to build an artificial-intelligence-generated content registry by:
receiving generated content from a generating service, wherein the generated content from the generating service is created using a generative artificial intelligence system;
assigning a service identifier to the generated content, wherein the service identifier is associated with the generating service;
deconstructing the generated content into a plurality of data segments;
for each data segment:
using a hashing algorithm to assign a segment identifier based on the content of the respective data segment;
linking the segment identifier with the service identifier; and
adding the segment identifier to a content group, wherein the content group comprises a plurality of segment identifiers for content generated by the generating service; and
storing the content group in a database.

2. (canceled)

3. The system of claim 1, wherein the generated content is multimedia content.

4. The system of claim 1, wherein the hashing algorithm is a perceptual hashing algorithm.

5-6. (canceled)

7. A method for collaborative generative artificial intelligence (GenAI) content identification and verification, comprising the steps of:
building an artificial-intelligence-generated content registry by:
receiving generated content from a generating service, wherein the generated content from the generating service is created using a generative artificial intelligence system;
assigning a service identifier to the generated content, wherein the service identifier is associated with the generating service;
deconstructing the generated content into a plurality of data segments;
for each data segment:
using a hashing algorithm to assign a segment identifier based on the content of the respective data segment;
linking the segment identifier with the service identifier; and
adding the segment identifier to a content group, wherein the content group comprises a plurality of segment identifiers for content generated by the generating service; and
storing the content group in a database.

8. (canceled)

9. The method of claim 7, wherein the generated content is multimedia content.

10. The method of claim 7, wherein the hashing algorithm is a perceptual hashing algorithm.

11-12. (canceled)

13. One or more non-transitory computer-storage media having computer-executable instructions embodied thereon that, when executed by one or more processors of a computing system employing a content registration subsystem, cause the computing system to perform the method of claim 7.
